(19) United States
(12) Patent Application Publication
(10) Pub. No.: US 2002/0178583 A1
(43) Pub. Date: Dec. 5, 2002

(54) Modular monolithic bulkhead panel

(76) Inventors: Wrenn P. Holman, Tacoma, WA (US); Robert W. Dost, Kent, WA (US); Ernest E. Williams JR., Kenmore, WA (US); Gary L. Richter, Port Orchard, WA (US); Juan Villalobos, Fort Worth, TX (US); Yida Gonzalez, Seattle, WA (US); Michael H. Volkmar, Tacoma, WA (US); Michael Byrd, Tacoma, WA (US); Francisco J. Boyer, Redmond, WA (US); Nasima Rahman, Issaquah, WA (US); William L. Saylor, Renton, WA (US); Patricia M. Hutchinson, Renton, WA (US); Chad L. Braunschweig, Sumner, WA (US); David J. Bauder, Kent, WA (US)

Correspondence Address: THE BOEING COMPANY, P.O. BOX 3707 M/C 13-08, SEATTLE, WA, 98124-2207, US

(21) Appl. No.: 10/066,163

(22) Filed: Jan. 31, 2002

Related U.S. Application Data
(60) Provisional application No. 60/276,563, filed on Mar. 14, 2001.

(51) Int. Cl. B64C 1/00; B23P 17/00; B21K 23/00; B21D 47/00

(52) U.S. Cl. 29/897; 244/119

(57) ABSTRACT

A modular monolithic metal framed bulkhead panel having a machined metal frame, a machined metal internal ring, a non-metallic panel subassembly, an adhesive backed silicone foam internal seal, and a frame seal common to the panel to structure interface.

### CROSS-REFERENCE TO RELATED APPLICATIONS

This application claims priority from provisional application serial No. 60/276,563, filed Mar. 14, 2001.

### BACKGROUND OF THE INVENTION

1. Technical Field

The present invention relates to panel structures and more particularly to panel structures of the type used in aircraft bulkheads.

Compartment Bulkheads used on modem airplanes are designed utilizing non-metallic composite hybrid thermosetting phenolic resin sandwich panels that can be peripherally framed or not depending on the space and design requirements unique to each bulkhead location. Framed panels are used in areas where aircraft structures do not allow sufficient edge margin space typically required for non-framed monolithic composite panels. Framed panels are also used in areas where extreme heat resistance and low smoke vapor toxicity emissions are required, or where the panel will be frequently removed in service—such as a maintenance access cover, and where fastener hole wear resistance is required. Finally monoltihic framing is used to prevent face sheets from delaminating from the composite panel core resulting from in service abuse. The modular nature of this built up structure has been attractive because it allows designers the flexibility of tailoring the composition of the panels to particular design requirements—such as high temperature, strength, noise attenuation as well as saving weight.

2. Background Art

Exemplary of prior art panel structures utilized in aircraft is U.S. Pat. No. 4,557,961 to Gorges issued Dec. 10, 1985 and assigned to The Boeing Company.

The state of the art metal-framed panel designs are labor intensively built up from multiple details which include machined parts, stretch formed parts, profiled extrusions, blanked sheet metal parts, non-metallic subassemblies and associated standards. Fabrication of the panel assemblies usually requires large tools to hold the panel periphery while the assembly of the panels is completed so that the edge margin alignment is maintained. Splice plates or integrated overlaps are required to attach one segment of the frame to another and all of these frame splices are completed using fasteners. All existing designs usually require a post assembly drilling operation utilizing drill templates or numerical control programs in efforts to provide controlled fastener patterns. Once the frames have been assembled additional labor intensive operations are required to seal and finish the panel, i.e., masking, local trimming, local primer touch up, enamel application, silicon sealing and the application of adhesive backed silicon foam seals.

### BREIF SUMMARY OF THE INVENTION

Disclosed is a modular monolithic cost-effective metal-framed bulkhead panel design. According to one aspect of the invention, the novel assembly reduces part count. According to another aspect of the invention, the novel assembly eliminates hard tooling requirements. According to yet another aspect of the invention, the novel assembly reduces fabrication time and reduces inventory requirements. According to still another aspect of the invention, the novel assembly allows for easy replacement of any component of this assembly that is damaged during handling or use. According to still yet another aspect of the invention, the novel assembly provides a robust reliable design by preventing the face sheets from delaminating from the honeycomb core resulting from in service abuse. The present monolithic bulkhead panel providing the above features and advantages utilizes a unique combination of only five basic components hereinafter described in detail.

### BRIEF DESCRIPTION OF THE SEVERAL VIEWS OF THE DRAWING

The above features and advantages of the present invention will become more readily apparent upon reading the following detailed description and upon reference to the attached drawings in which:

FIG. 1 is an exploded view of the state of the art panel design used in prior art;

FIG. 2 is exemplary of the prior art multiple part panel design;

FIG. 3 is an exploded view of a modular monolithic panel embodying the present invention;

FIG. 4 is exemplary of a modular monolithic panel in accordance with the present invention; and

FIG. 5 is a perspective view of a preferred embodiment of the present invention in the compartment bulkhead structure of an aircraft.

### DETAILED DESCRIPTION OF THE INVENTION

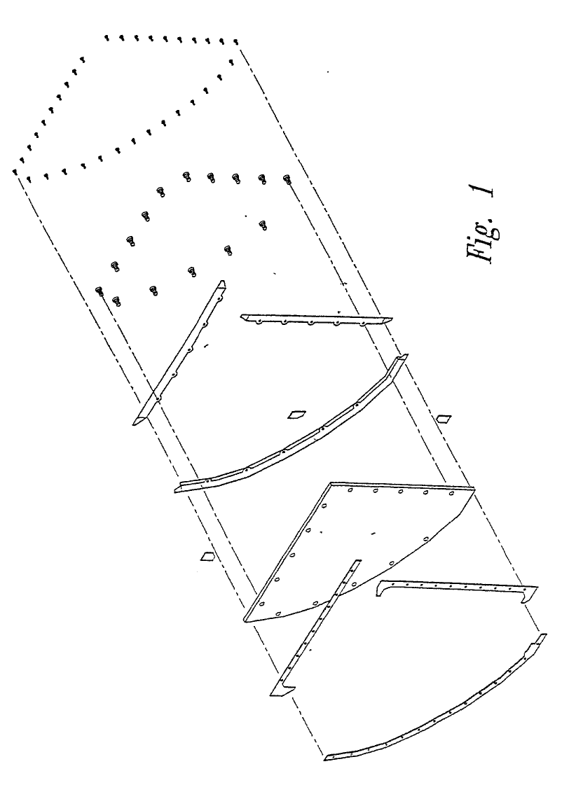

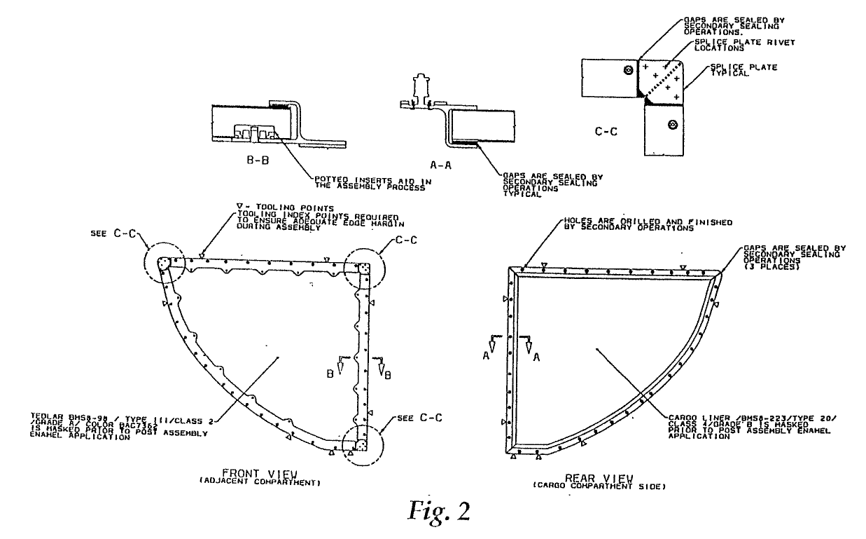

Turning now to the drawings, there is shown in FIGS. 1 and 2 a prior art metal-framed panel structure of multiple part design.

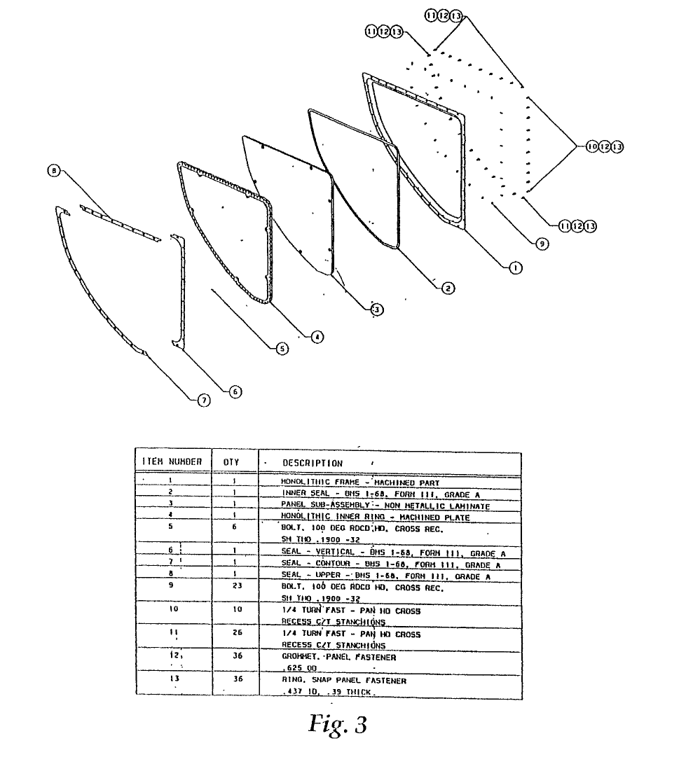

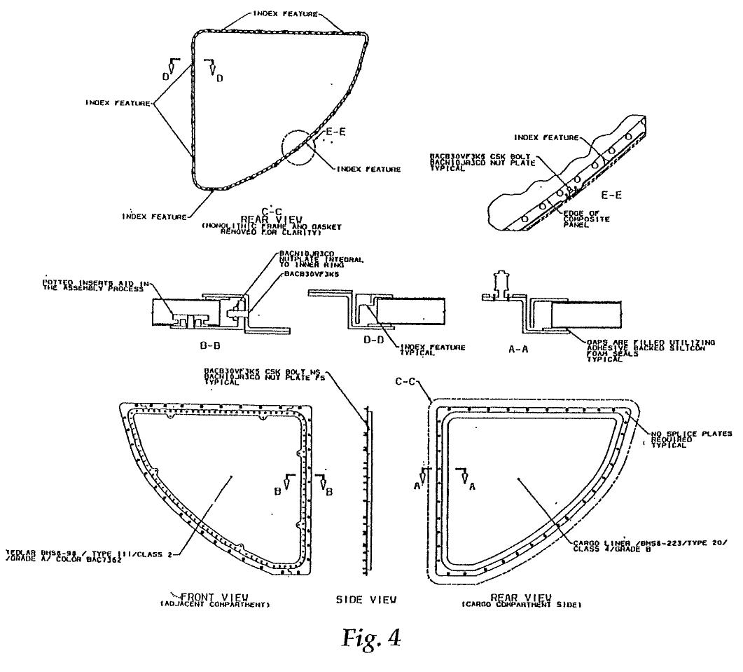

Turning now to FIGS. 3 and 4 of the drawings, like numerals being used for like and corresponding parts of the various drawings, it will be seen that a robust modular monolithic cost effective bulkhead panel design is seen which eliminates labor intensive assembly process, reduces part count, reduces fabrication costs and reduces inventory requirements. The present monolithic bulkhead panel design provides that fabrication and final protective finishes can be incorporated at the detail level and the assembly of the present monolithic panel can be accomplished on the bench with standard hand tools utilizing standard hardware and adhesive backed seals. This design approach greatly reduces reoccurring assembly labor. The detail part count for a panel assembly is reduced over the prior art designs in an effort to reduce fabrication time and lower the associated inventory cost. Components of the assembly cab easily be replaced should they become damaged during handling or use.

The present monolithic bulkhead panel comprises five basic components as seen in FIG. 3: 1) Machined metal frame 1 gauged in support of fire worthiness directives addressing metal degradation (with nutplates), 2) machined metal internal ring 4 with nutplates), 3) non-metallic hybrid composite panel subassembly 3 with potted inserts, 4) adhesive backed silicone foam internal seal (one seal or multiple interlocking seals); and 5) one frame seal (one seal or multiple interlocking seals) common to the panel structure interface. Machined metal frame 1 is machined from aluminum plate that is complete with all of the required hardware and final finishes. Inner ring 4 is machined from aluminum plate and comes the required hardware and final finishes. Ring 4 contains integral panel indexing features as seen in FIG. 4 that insures alignment of the nonmetallic hybrid composite panel during the assembly process. A non-metallic hybrid composite panel mislocation could compromise the resilience to fire and smoke propagation effects. The non-metallic panel subassembly is complete with floating potted inserts, which aid in the assembly process. The adhesive backed silicon foam seals as seen in section A-A of FIG. 4 are peripherally precut to support simple application by the fabrication center mechanics. The entire assembly can be bolted together by fabrication personnel utilizing standard fasteners and hand tools.

The method of assembly of the present modular monolithic bulkhead panel includes the steps of utilizing a first metal frame for holding the present composite panel and then utilizing a second metal frame for retaining the composite panel in the first metal frame. A gasket is utilized for sealing the joint between the composite panel and the first and second frames, the gasket being inserted into the first metal frame. The composite panel is then inserted into the gasket and first metal frame subassembly. The second frame is then inserted into the subassembly and the first and second metal frames are then joined.

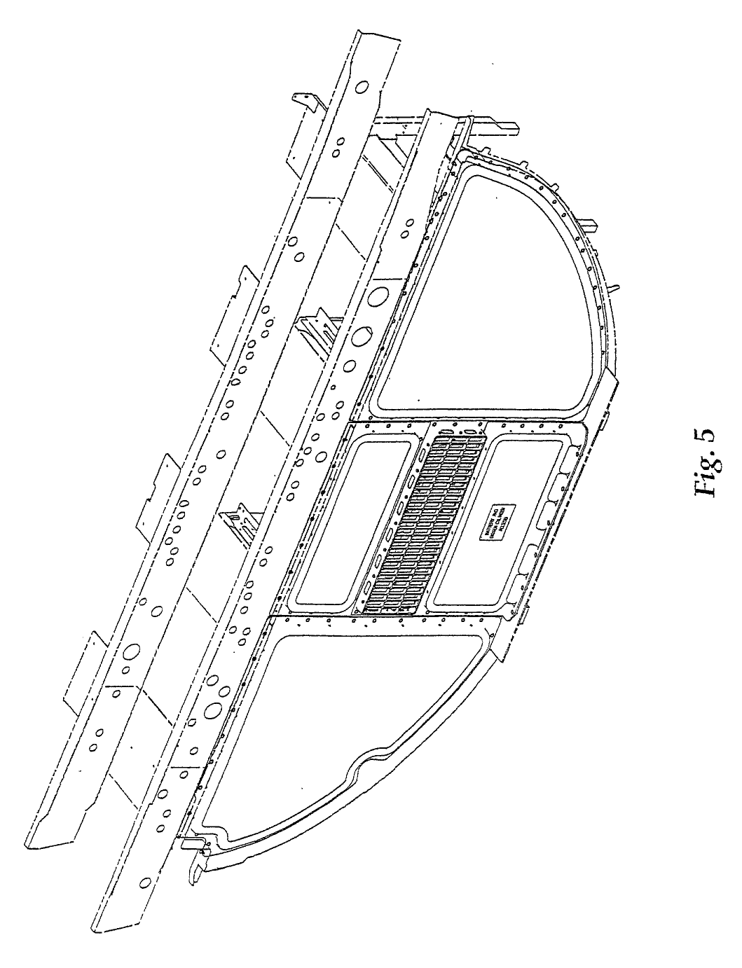

FIG. 5 is illustrative of the present modular monolithic panel shown in the compartment bulkhead structure of an aircraft.

A composite panel which utilizes any combination of graphite, a carbon fiber reinforced plastic material; Kevlar, an aramid fiber prepreg material; or fiberglass, a glass reinforced plastic material is referred to hereinabove as the hybrid composite panel.

1. A method of constructing a modular monolithic bulkhead panel comprising the steps of:
providing a composite panel
providing a first metal frame for holding said composite panel
providing a second metal frame for retaining said composite panel in first metal frame;
providing a gasket for sealing joint between composite panel and said first and second metal frames;
inserting said gasket into said first metal frame
inserting said composite panel into said gasket and first metal frame subassembly;
inserting said second metal frame into said subassembly; and
joining said first and second metal frame.

2. A modular monolithic bulkhead panel assembly comprising:
a composite panel
a first frame for holding a hybrid composite panel;
a second for retaining said hybrid composite panel in first metal frame; and
a gasket for sealing joint between hybrid composite panel and said first and second metal frames.

3. The panel assembly as in claim 2, wherein the first and second frames are metallic.

4. The panel assembly as in claim 2, wherein the first and second frames are composite.

5. The panel assembly as in claim 3, wherein the first and second metallic frames have a directed internal grain structure to enhance strength.

6. The panel assembly as in claim 3, wherein the first and second metallic frames have a uniform internal grain structure

7. The panel assembly as in claim 3, wherein the first and second metallic frames are formed by a machining process.

8. The panel assembly as in claim 3, wherein the first and second metallic frames are formed by casting.

9. The panel assembly as in claim 3, wherein the first and second metallic frames are formed by a drawn process.

10. The panel assembly as in claim 2, wherein the gasket is an elastomer.

11. The panel assembly as in claim 2, wherein the gasket is silicone

12. The panel assembly as in claim 2, wherein the gasket is silicone foam.

13. The panel assembly as in claim 2, wherein the gasket is an adhesive

14. The adhesive as in claim 13, wherein it is of the high temperature cure variety

15. The adhesive in claim 13, wherein it is of the cold temperature cure variety

16. The panel assembly as in claim 2, wherein the panel is of a thermosetting sandwich construction.

17. The thermosetting sandwich panel as in claim 14, wherein the plys comprise woven graphite fabric and high temperature phenolic resin.

18. The panel assembly as in claim 2, wherein the fastener is a rivet.

19. The panel assembly as in claim 2, wherein the fastener is a threaded fastener

20. The panel assembly as in claim 2, wherein the fastener is an adhesive.

21. The panel assembly as in claim 2, wherein the fastener is a weld.

22. A modular monolithic bulkhead panel assembly comprising in combination:
a hybrid composite panel
a two-piece H-channel retention and mounting frame for retaining said hybrid composite panel: and,
sealing means between two-piece H-Channel retention and mounting frame and said hybrid composite panel.

23. The invention according to claim 22, wherein said sealing means comprises an elastomer sealing gasket.

24. An aircraft bulkhead structure, said aircraft bulkhead structure including a plurality of metal framed modular monolithic bulkhead panels; each of said plurality of metal framed modular monolithic bulkhead panels including a machined metal frame with nutplates, a machined metal internal ring with nutplates, a non-metallic hybrid composite panel sub assembly with potted inserts, adhesive backed silicone foam internal sealing means, and a frame sealing means common to said panel and structure interface.
